(19) United States
(12) Patent Application Publication
(10) Pub. No.: US 2002/0129594 A1
(43) Pub. Date: Sep. 19, 2002

(54) Ergonomic rake having a flexible handle

(76) Inventor: Michael Gullotti, Jamestown, NY (US)

Correspondence Address: Webb Ziesenheim Logsdon Orkin & Hanson PC, 700 Koppers Building, 436 Seventh Avenue, Pittsburgh, PA, 15219-1818, US

(21) Appl. No.: 09/810,701

(22) Filed: Mar. 16, 2001

(51) Int. Cl. B25G 1/00; A01D 7/00

(52) U.S. Cl. 56/400.01; 15/143.1

(57) ABSTRACT

The ergonomic rake includes an elongated handle having a first end and a second end. The handle further includes a flexible portion defined by a plurality of bends formed adjacent the second end for allowing the handle to flex when downward pressure is applied by a user of the rake. The ergonomic rake further includes a rake head having a web portion and a plurality of rake tines extending from the web portion. The rake head is connected to the second end of the handle. The rake head is preferably secured to the second end of the handle such that the rake head and handle remain connected when the rake is in use. The flexible portion of the handle may form between about 10% and 30% of the overall length of the handle.

### BACKGROUND OF THE INVENTION

1. Field of the Invention

The present invention relates to lawn rakes and, more particularly, to an ergonomically designed rake that helps avoid injuries to the user and is more efficient at gathering yard debris.

2. Description of the Prior Art

Lawn and yard rakes are standard hand tools used for gathering grass, leaves, and other light yard debris. Standard yard rakes have an elongated, straight and rigid handle attached to a rake head. The handle is typically made of strong but lightweight materials such as wood, aluminum, light gauge steel, or hard plastic. The rake head is typically made of lightweight and resilient material such as bamboo, plastic, or thin metal strips. Yard rakes are used sporadically, with most use coming during the spring and fall seasons for obvious reasons. Often, persons not accustomed to doing manual labor use yard rakes. Standard yard rakes with straight handles and semi-resilient rake heads require a great deal of upper body strength to use. Over the years attempts have been made to improve upon the standard rake design having a straight handle and semi-resilient rake head.

U.S. Pat. No. 2,423,772 to Haase teaches a rake having spring-biased tines in the rake head that may be deflected up to 90°. U.S. Pat. No. 2,119,165 to Hörnstein teaches a rake with a spring-biased rake head. U.S. Pat. No. 4,189,908 to Brock, Jr. teaches a flexible rake having a rake head with a plurality of flexible tines that extend forward from a rigid, laterally extending support panel. U.S. Pat. No. 4,791,780 to Phillips teaches a rake having an “S-shaped” angled handle allowing a user to rake forward with a forward sweeping motion. U.S. Pat. No. 4,985,961 to Kegley teaches a hand tool having a rake face and handle, with the handle including a pair of longitudinal gripping members having parallel axes and a connection member connecting the gripping members. U.S. Pat. Nos. 5,249,413 and Re. 35,604, both to McDonough, Jr., teach rakes having three pivotally mounted rake heads. The rake heads include springs that allow the rake heads to flex relative to the longitudinal axis of the rake handle, but also generally maintain a substantially parallel relationship between the three rake heads. U.S. Pat. No. 5,555,711 to Costa teaches a lawn rake having a spring pivoting rake head. The lawn rake disclosed by Costa incorporates a spring element that permits the rake head to flex relative to the longitudinal axis of the rake handle. U.S. Pat. No. 5,878,563 to Dutcher teaches a rake having a rake head inclined at a 45° angle with the rake handle. The rake disclosed by Dutcher further includes a pivotable support stand that is used to support the rake in an upright position when not in use. U.S. Pat. No. 6,023,924 to Babineau teaches a rake having a rake head and a handle formed with upper and lower offset handgrips.

An object of the present invention is to provide an improved lawn and yard rake that requires less physical strength to use. It is another object of the present invention to provide a lawn and yard rake that has an improved handle. Further, it is an object of the present invention to generally improve upon the prior art.

### SUMMARY OF THE INVENTION

The above objects are accomplished with an ergonomic rake made in accordance with the present invention. The ergonomic rake includes an elongated handle having a first end and a second end. The handle further includes a flexible portion defined by a plurality of bends formed adjacent the second end for allowing the handle to flex when downward pressure is applied by a user of the rake. The ergonomic rake further includes a rake head having a web portion and a plurality of rake tines extending from the web portion. The rake head is connected to the second end of the handle. The rake head is preferably secured to the second end of the handle such that the rake head and handle remain connected when the rake is in use. The flexible portion of the handle may comprise between about 10% and 30% of the overall length of the handle. The handle may be an elongated hollow tube made of plastic. The plurality of bends forming the flexible portion of the handle may include between about four and six bends. The handle and rake head may be integrally formed as a one-piece unit from molded plastic material. The rake head may be secured to the second end of the handle by at least one mechanical fastener. The handle may include a handgrip located adjacent the first end of the handle for grasping by the user of the rake. The handgrip may be integrally formed in the handle adjacent the first end of the handle.

The present invention is also an ergonomic broom. The ergonomic broom includes a handle having a first end and a second end. The handle further includes a flexible portion defined by a plurality of bends formed adjacent the second end for allowing the handle to flex when downward pressure is applied by a user of the broom. A broom head is fixedly secured to the second end of the handle such that the handle and broom head remain connected when the broom is in use.

Further details and advantages of the present invention will become apparent from the detailed description read in conjunction with the drawings.

### BRIEF DESCRIPTION OF THE DRAWINGS

FIG. 1 is a front elevational view showing a handle and rake head of the ergonomic rake of the present invention;

FIG. 2 is a perspective view of the assembled ergonomic rake of the present invention;

FIG. 3 is a front elevational view of the ergonomic rake;

FIG. 4 is a side elevational view of the ergonomic rake;

FIG. 5 is a perspective view of an ergonomic broom according to a another embodiment of the present invention; and

FIG. 6 is a perspective view showing a person using the ergonomic rake of the present invention.

### DETAILED DESCRIPTION OF THE PREFERRED EMBODIMENTS

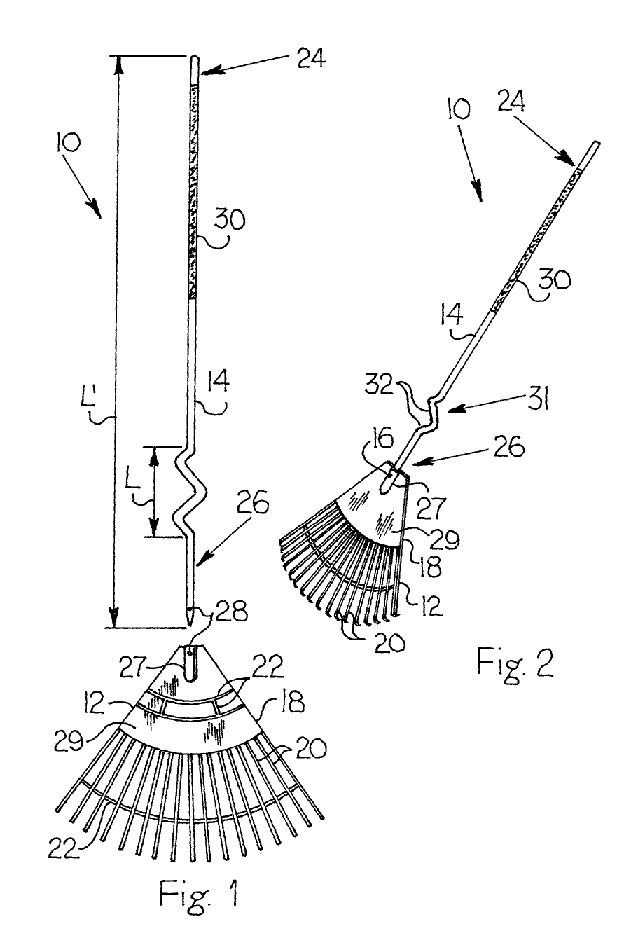

Referring to FIGS. 1-4, an ergonomic rake 10 made in accordance with the present invention is shown. The rake 10 includes a rake head 12 and an elongated handle 14. The rake head 12 is secured to the handle 14 by a mechanical fastener 16 such as a pin lock, bolt and nut combination, rivet, or by any other equivalent means known in the art. The mechanical fastener 16 may also be replaced by a threaded connection between the rake head 12 and the end of the handle 14, as discussed hereinafter. The mechanical fastener 16 is preferably removable so that in the event either the rake head 12 or handle 14 break the broken part may be replaced. The present invention also envisions that the rake head 12 and handle 14 may be integrally formed, with the rake head 12 and handle 14 formed as a one-piece unit.

The rake head 12, as is customary, is generally triangular-shaped. The rake head 12 includes a triangular-shaped web portion 18. A plurality of rake tines 20 extend from the web portion 18. The web portion 18 and tines 20 may be integrally formed. Alternatively, the rake tines 20 may be individually affixed to the web portion 18 by methods customary in the art. The rake tines 20 are curved at one end in a conventional manner. Thus, the rake head 12 has a rear or ground engaging side or face 13 facing the same direction as the curved ends of the tines 20, as shown in FIG. 4.

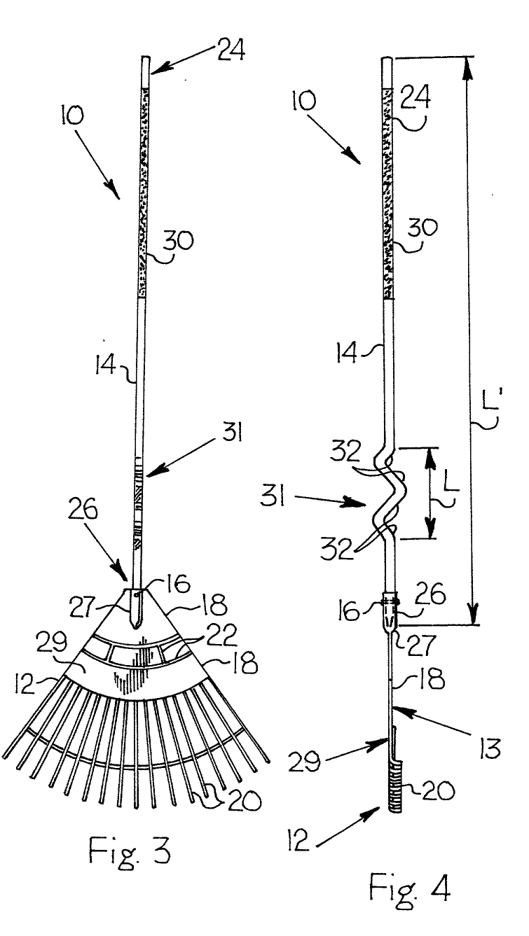

The rake head 12 may have reinforcing strips 22 attached to the web portion 18 and tines 20. As shown, for example, in FIGS. 1 and 3, the reinforcing strips 22 may extend transversely across the rake head 12 as well as longitudinally along the rake head 12. The reinforcing strips 22 may be provided as ribs formed integrally with the web portion 18. The reinforcing strips 22 may be metal or plastic. The rake head 12 is preferably fabricated from molded plastic material, which makes formation of the aforementioned ribs a simple process. The rake head 12 may also be formed of other materials including lightweight metal such as aluminum or light gauge steel, lightweight wood such as bamboo, and fiberglass. The rake head 12 may have any suitable dimensions. A suitable dimension for most domestic lawn and yard uses is about twenty-four inches across the widest part of the rake head 12.

The handle 14 includes a first end 24 and a second end 26. The second end 26 is secured to the rake head 12 by the mechanical fastener 16 as discussed previously. As shown in FIG. 4, the second end 26 of the handle 14 is inserted into a socket or sleeve 27 formed at the apex of the web portion 18. The mechanical fastener 16 extends through an aperture 28 extending through the sidewall of the socket 27 and the second end 26 of the handle 14 to secure the connection between the handle 14 and the rake head 12. The aperture 28 for the mechanical fastener 16 is preferably oriented substantially perpendicular to a front or “non-engaging” side or face 29 of the rake head 12. The mechanical fastener 16 may be replaced by a thread connection between the second end 26 of the handle 14 and the socket 27. Such a threaded connection would include internal threads in the socket 27 and mating external threads on the second end 26 of the handle 14.

The elongated handle 14 may have any overall length. The handle 14 is preferably provided as an elongated hollow or solid tube. A suitable length for the handle 14 that is comfortable for most people is between about four to six feet. The handle 14 and, preferably, the rake head 12 are made of a flexible plastic material such as molded plastic, metal, or wood. The handle 14 and rake head 12, while being to some degree resiliently flexible, are rigid enough to withstand typical domestic raking applications such as leaf raking or lawn raking without permanently deforming or breaking. The material comprising the handle 14 and rake head 12 are selected accordingly.

A handgrip 30 is preferably provided adjacent the first end 24 of the handle 14. The handgrip 30 may be formed into the handle 14 which, as stated previously, is preferably made of molded plastic material. Thus, the formation of an integral handgrip 30 may be added to the molding process for the handle 14. The handgrip 30 may also be a rubber sleeve or grip that is placed over the first end 24 of the handle 14. The handgrip 30 may have any suitable dimension. A suitable dimension for most people is between about twelve and eighteen inches long.

The handle 14 further includes a flexible portion 31 defined by a plurality of bends 32 formed adjacent the second end 26 of the handle 14. The bends 32 are preferably aligned with a plane that is substantially perpendicular to a plane defined by the substantially front side 29 of the rake head 12, as shown in FIG. 4. Alternatively, the bends 32 may be oriented in a plane substantially coincident with the plane defined by the front side 29 of the rake head 12, as shown in FIG. 1. The flexible portion 31 may have any number of bends 32, but in a preferred embodiment of the present invention four to six bends 32 are included in the flexible portion 31. The bends 32 may be formed at angles of about 30° and 60° between each other. The flexible portion 31 has an overall distance L of about eight inches in a preferred embodiment of the handle 14. The overall distance L of the flexible portion 31 preferably comprises between about 10% and 30% of the overall distance L′ of the handle 14, as shown in FIG. 4. Thus, with a handle 14 having an overall length of four feet (48 inches), the overall distance of the flexible portion 31 may be between about 4.5 inches and 14.5 inches. The flexible portion 31 is integrally formed with the handle 14, but may also be made of a different material than the remainder of the handle 14. For example, the handle 14 may be made of wood or metal with the flexible portion 31 made of plastic and secured at either end thereof to the handle 14. Such connectives may be secured by mechanical fasteners, or by other means customary in the art.

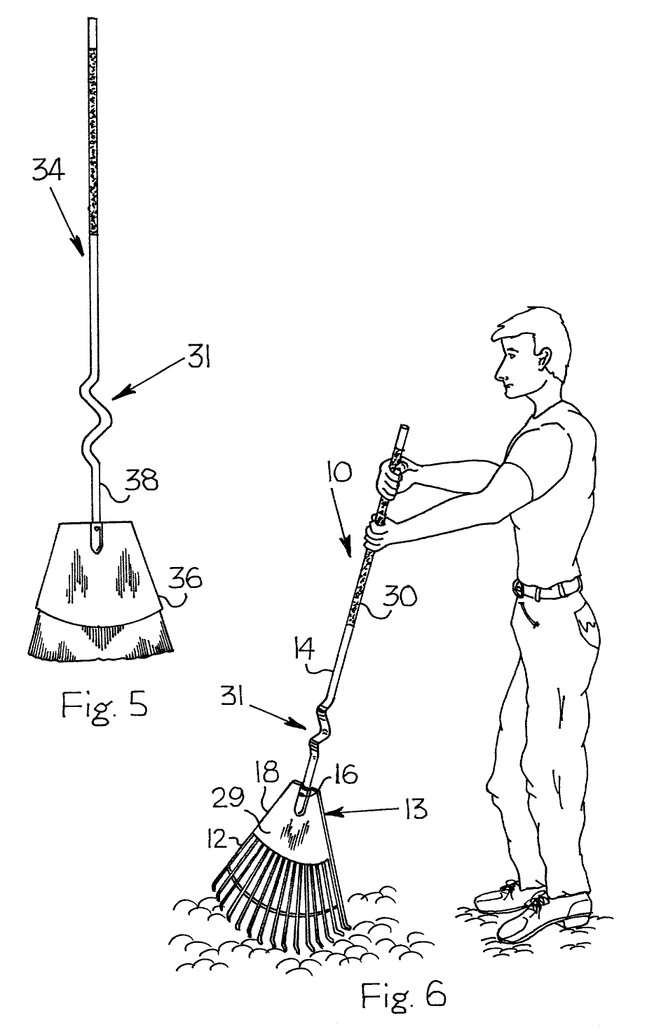

Referring to FIG. 5, a second embodiment of the present invention is shown and is directed to an ergonomic broom 34. The present invention further envisions that a broom head 36 may replace the rake head 12. The broom head 36 is connected to handle 38 in a similar manner to the rake head 12 and handle 14 discussed previously. The handle 38 used with the broom head 36 in the broom 34 is identical to the handle 14 discussed previously. The broom head 36 may be a conventional straw broom head or contain plastic bristles as are well known in the art. The dimensions given previously for the handle 14 may also be applied to the handle 38.

Referring to FIG. 6, in operation, the user will place the rake head 12 in contact with the ground, with the tines 20 touching the ground. The user will make normal raking movements with the rake 10 gathering any leaves, grass, or other debris with the rake head 12. While making normal raking movements, the user maintains light downward pressure on the rake head 12. The flexible portion 31 allows the handle to bend and flex as the rake head 12 moves over the ground. The bending and flexing provided by the flexible portion 31 causes the rake head 12 to tightly grab the ground and securely contain the raked material under the rake head 12. Additionally, the bending and flexing provided by the flexible portion 31 enables the user to exert less force with his or her back muscles, shoulder, and arm muscles over prior art rakes having traditional rigid handles 14. The present invention further envisions that the handle 14 may be used with any type of hand tool where it is necessary or desirable for the handle of the implement to bend and flex under work conditions. Thus, the handle 14 is uniquely suited for use as a replacement handle for most types of lawn and garden hand tools.

The rake 10 of the present invention provides an improved lawn and yard rake that requires less physical strength to use. In addition, the rake 10 of the present invention provides a lawn and yard rake that has an improved, flexible handle 14 that makes the rake 10 operate more efficiently and with less physical force required from the user. Further, the rake 10 of the present invention also generally improves upon the prior art.

While the presently preferred embodiments of the invention were described hereinabove, obvious modifications and alterations of the invention may be made without departing from the spirit and scope of the invention. The invention is defined hereinafter in the appended claims and equivalents thereto.

I claim:

1. An ergonomic rake, comprising:
an elongated handle having a first end and a second, with the handle having a flexible portion defined by plurality of bends formed adjacent the second end allowing the handle to flex when downward pressure is applied by a user of the rake;
a rake head having a web portion and a plurality of rake tines extending from the web portion, with the rake head connected to the second end of the handle,
wherein the rake head is fixedly secured to the second end of the handle such that the rake head and handle remain connected when the rake is in use.

2. The ergonomic rake of claim 1, wherein the flexible portion comprises between about 10% and 30% of the length of the handle.

3. The ergonomic rake of claim 1, wherein the handle is an elongated hollow tube made of plastic.

4. The ergonomic rake of claim 1, wherein the plurality of bends forming the flexible portion is comprised of between about four and six bends.

5. The ergonomic rake of claim 1, wherein the handle and rake head are integrally formed as a one-piece unit from molded plastic material.

6. The ergonomic rake of claim 1, wherein the rake head is secured to the second end of the handle by at least one mechanical fastener.

7. The ergonomic rake of claim 1, wherein the handle includes a handgrip located adjacent the first end of the handle for grasping by the user of the rake.

8. The ergonomic rake of claim 8, wherein the handle is an elongated hollow tube made of plastic, and wherein the handgrip is integrally formed in the handle adjacent the first end of the handle.

9. A flexible handle for use with a hand tool, comprising:
an elongated hollow tube having a first end and a second end, with the second end configured for connection to the hand tool, and with the elongated tube having a flexible portion defined by a plurality of bends formed adjacent the second end allowing the handle to flex when downward pressure is applied to the handle by a user.

10. The flexible handle of claim 9, wherein the flexible portion comprises between about 10% and 30% of the length of the elongated tube comprising the handle.

11. The flexible handle of claim 9, wherein the elongated tube is made of plastic.

12. The flexible handle of claim 9, wherein the plurality of bends forming the flexible portion is comprised of between about four and six bends.

13. The flexible handle of claim 9, wherein the elongated tube is made of plastic and includes an integrally formed handgrip located adjacent the first end of the elongated tube for grasping by the user.

14. An ergonomic broom, comprising:
an elongated handle having a first end and a second end, with the handle having a flexible portion defined by a plurality of bends formed adjacent the second end allowing the handle to flex when downward pressure is applied by a user of the broom;
a broom head fixedly secured to the second end of the handle such that the handle and broom head remain connected when the broom is in use.

15. The ergonomic broom of claim 14, wherein the flexible portion comprises between about 10% and 30% of the length of the handle.

16. The ergonomic broom of claim 14, wherein the handle is an elongated hollow tube made of plastic.

17. The ergonomic broom of claim 14, wherein the plurality of bends forming the flexible portion is comprised of between about four and six bends.

18. The ergonomic broom of claim 14, wherein the broom head is secured to the second end of the handle by at least one mechanical fastener.

19. The ergonomic broom of claim 14, wherein the handle includes a handgrip located adjacent the first end of the handle for grasping by the user of the broom.

20. The ergonomic broom of claim 19, wherein the handle is an elongated hollow tube made of plastic, and wherein the handgrip is integrally formed in the handle adjacent the first end of the handle.
